(19) United States
(12) Patent Application Publication
(10) Pub. No.: US 2005/0227043 A1
(43) Pub. Date: Oct. 13, 2005

(54) Two-shot polymeric component with wrapped edge and a method of producing same

(75) Inventors: Michael P. Schoemann, Waterford, MI (US); Randy S. Reed, Fair Haven, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/852,615

(22) Filed: May 24, 2004

Related U.S. Application Data
(63) Continuation-in-part of application No. 10/821,058, filed on Apr. 8, 2004.

(51) Int. Cl. B32B 3/10; B29C 45/16

(52) U.S. Cl. 428/137; 264/255

(57) ABSTRACT

A method for producing a two-shot polymeric component having one shot wrapped around an edge of the other shot, includes injection molding a first portion having first and second opposing sides and an edge adjacent the first and second sides. A second portion is injection molded such that some of the second portion contacts the first side of the first portion, some of the second portion contacts the second side of the first portion, and some of the second portion contacts the edge. The second portion forms a unitary structure wrapping around the edge of the first portion.

### CROSS-REFERENCE TO RELATED APPLICATIONS

This application is a continuation-in-part of U.S. application Ser. No. 10/821,058 filed Apr. 8, 2004, which is hereby incorporated by reference in its entirety.

### BACKGROUND OF THE INVENTION

1. Field of the Invention

The present invention relates to a two-shot polymeric component having a wrapped edge, and a method of producing such a component.

2. Background Art

Polymeric materials are used today in an ever increasing number of different applications. Whether it is in a structural application, or one designed primarily for aesthetics, the use of polymeric materials often provides a light weight and less expensive alternative to materials such as metals. The use of polymeric materials in vehicles in one example. The interior of many vehicles contains a wide variety of polymeric components—e.g., door panels, instrument panels, headliners and pillar trim components, just to name a few. In some cases, at least a portion of the as-molded polymeric component is covered with a cloth, or other material, to add to the aesthetics of the component. In addition, cloth or other material may be wrapped around an edge of the as-molded component, particularly when such edge may be contacted by a vehicle occupant. This type of configuration may be found in such interior components as map pockets and coin trays.

In addition to those components mentioned above, other vehicle components, such as door and instrument panel bezels and pillar trim covers, may also have an edge wrapped with a material-not necessarily for aesthetic purposes, but to address buzz, squeak and rattle (BSR) concerns. In many cases, another polymeric material, rather than cloth, will be used to wrap the edge of the bezel or pillar trim component to help ensure that the interior of the vehicle is quiet when the vehicle is being operated. Usually, the polymeric material used on the edge of the trim component is softer than the trim component itself, and helps to keep the trim component stationary in the presence of vibrations associated with the vehicle operation.

In each of these cases, a secondary operation is required after the trim component is initially molded. In the case of the pillar trim component or bezel, the secondary polymeric material needs to be placed on the edge of the trim component, and is usually bonded with some form of adhesive. When cloth is used to cover the edge of a trim component, adhesive may be used and/or the cloth may be tacked to the trim component. Thus, labor and material costs are increased, as is cycle time for completion of the vehicle interior component.

Recently, two-shot molding has been used to create polymeric components have one shot overlaid on another shot. In some cases, each shot is made from a different polymeric material while in other cases, both shots are made from the same material. In either case, the two-shot molding can be performed in a single mold. When different polymeric materials are used for each shot, the first shot may form a structural portion of the component, while the second shot may provide aesthetics or other functionality. Some two-shot processes provide a second shot of polymeric material that is disposed on a surface of the first shot, and is also disposed on an edge of the first shot. One limitation of this method is that it still does not allow the second shot to be fully wrapped around the edge of the first shot. Therefore, in the case of a pillar trim component or bezel, the second shot may not cover the edge of the first shot adequately to eliminate the BSR noises associated with the trim component during vehicle operation. In the case of the map pocket, or other component contacted by a vehicle occupant, having the second shot disposed over one surface and an adjacent edge does not cover the edge as thoroughly as applying a separate material in a secondary operation.

Therefore, a need exists for a method for producing a two-shot polymeric component having one shot wrapped around an edge of the other shot.

### SUMMARY OF THE INVENTION

Accordingly, the present invention provides a method for producing a two-shot polymeric component having one shot wrapped around an edge of the other shot.

The invention also provides a method for producing a two-shot polymeric component having one shot wrapped around an edge of another shot, where the method includes injection molding a first portion having first and second opposing sides and an edge adjacent the first and second sides. A second portion is injection molded such that some of the second portion contacts the first side of the first portion, some of the second portion contacts the second side of the first portion, and some of the second portion contacts the edge. The second portion forms a unitary structure wrapping around the edge of the first portion.

The invention further provides a method for producing a two-shot vehicle trim component having one shot wrapped around an edge of another shot. The method includes injection molding a structural portion having a show side and back side and an edge adjacent the show side and the back side. A skin is injection molded such that some of the skin contacts the show side of the structural portion, some of the skin contacts the back side of the structural portion, and some of the skin contacts the edge. The skin forms a unitary structure wrapping around the edge of the structural portion.

The invention also provides a two-shot injection molded polymeric component, including a first portion having first and second opposing sides and an edge adjacent the first and second sides. A second portion is molded over at least some of the first and second sides and the edge of the first portion. The second portion forms a unitary structure that wraps around the edge of the first portion.

### BRIEF DESCRIPTION OF THE DRAWINGS

FIG. 1 is flow chart illustrating the steps in accordance with a method of the present invention;

FIGS. 2A and 2B are fragmentary plan views of a portion of a mold used to produce a polymeric component in accordance with the present invention;

FIGS. 3A and 3B are fragmentary plan views of a mold used to produce an alternative embodiment of the present invention; and

FIGS. 4A and 4B are fragmentary plan views of a mold used to produce a second alternative embodiment of the present invention.

### DETAILED DESCRIPTION OF THE PREFERRED EMBODIMENT(S)

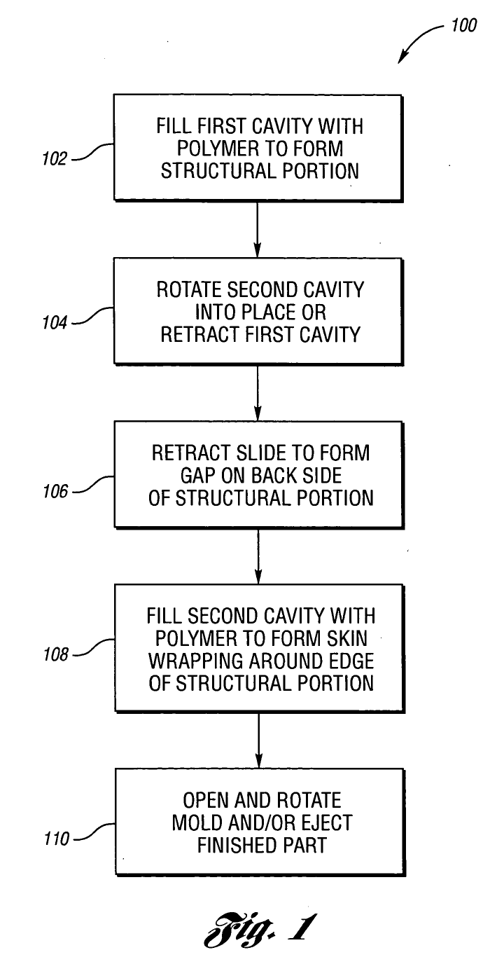

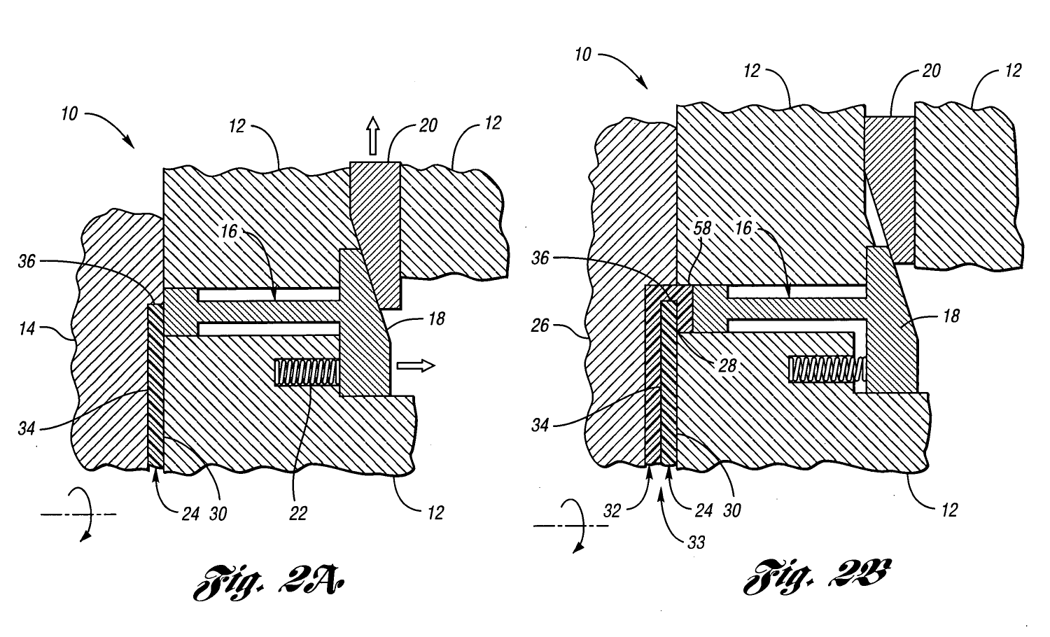

FIG. 1 shows a flow chart 100 illustrating a method in accordance with the present invention. The steps in the flow chart 100 are explained with reference to FIGS. 2A and 2B, which illustrate portions of a mold 10 configured to produce a two-shot polymeric component. As shown in FIG. 2A, the mold 10 includes a core 12, a first cavity 14, and a retractable slide 16. The slide 16 includes a first wedge 18, which in the embodiment shown in FIG. 2A, is integral with the slide 16. Of course, a wedge, such as the wedge 18, could be a separate piece attached to the slide 16 by any convenient method. A second wedge 20 cooperates with the first wedge 18 to facilitate linear movement of the slide 16. A spring 22 cooperates with the first wedge 18 to apply a force thereto. As explained more fully below, the interaction of the wedges 18, 20 and the spring 22 facilitate molding of the second shot of a two-shot polymeric component.

Returning to FIG. 1, the first step 102 includes filling the first cavity 14 with a polymeric material to form a first portion, or first shot 24—see FIG. 2A. The first shot 24 forms a structural portion, since the two-shot polymeric component shown in FIGS. 2A and 2B is configured for use as a vehicle trim component. Therefore, the first shot 24 may be made from a relatively strong polymer such as polypropylene, acrylonitrile butadiene styrene (ABS), or polycarbonate acrylonitrile butadiene styrene (PC-ABS), just to name a few.

At step 104, shown in FIG. 1, the first cavity 14 is retracted, or alternatively, the first cavity 14 is rotated away from the first shot 24 as shown by the rotational arrow in FIG. 2A. As the first cavity 14 is rotated away from the first shot 24, a second cavity 26 is rotated into place adjacent the first shot 24—see FIG. 2B. Returning to FIG. 1, it is shown that step 106 includes retracting the slide 16 to form a gap 28 on a back side 30 of the first shot 24. Although steps 104 and 106 are shown in the flow chart 100 as occurring sequentially, it is worth noting that they need not occur in any particular order, and in fact, may be performed concurrently if desired. Once the second cavity 26 is in place, and the slide 16 is retracted, the second cavity 26 and the gap 28, which form a space around some of the first portion 24, are filled with a polymeric material to form a second portion, or second shot 32—see step 108. The second shot 32 forms a skin over the first shot 24, and provides aesthetics and/or functionality to the vehicle trim component 33—see FIG. 2B. Finally, at step 110 the mold 10 is opened and the finished component 33, is ejected. Alternatively, in a production setting, a portion of the mold 10 could be rotated so that another component is being molded while the first component is ejected or otherwise removed.

Although the slide 16 may be actuated by any method effective to move it away from the back side 30 of the first shot 24, the first and second wedges 18, 20, shown in FIGS. 2A and 2B, illustrate one method. As shown in FIG. 2A, the second wedge 20 is movable in a direction illustrated by the directional arrow vertically oriented in FIG. 2A. Movement of the second wedge 20 may be effected by a hydraulic or pneumatic cylinder, or some other mechanism effective to move the second wedge 20 away from the first wedge 18. As the second wedge 20 is moved away from the first wedge 18, the force exerted by the spring 22 on the wedge 18, causes the slide 16 to move along a direction indicated by the horizontal directional arrow shown in FIG. 2A. Although conveniently referred to as “a” force, it is understood that a spring, such as the spring 22 imparts a force that is directly related to its deflection, and therefore, the force of the spring 22 on the wedge 18 will vary as the slide 16 moves linearly.

As shown in FIG. 2A, the first shot 24 includes first and second opposing sides, which, in the case of the vehicle trim component, are respectively a show side 34, and a back side 30 discussed above. Adjacent the show side 34 and the back side 30 is an edge 36. It is the edge 36 that is covered by the second shot 32, as clearly shown in FIG. 2B. Thus, the second shot 32 forms a unitary structure that not only contacts some of the show side 34 and the edge 36, but also wraps completely around the edge 36 to contact some of the back side 30.

As discussed above, the two-shot component 33 is intended for use as a vehicle trim component, and as such, the first shot 24 forms a structural portion, while the second shot 32 forms a skin over the structural portion. Although the second shot 32 can be made from the same polymeric material as the first shot 24, it may be desirable to make the second shot 32 from a softer material, particularly when it is designed to inhibit BSR noises in the vehicle. In such a case, the second shot 32 may be made from a polymer such as a thermoplastic elastomer (TPE) a thermoplastic polyolefin (TPO), or a thermoplastic vulcanizate (TPV). The first and second shots 24, 32, forming the vehicle trim component 33, may be a part of any of a number of different types of vehicle trim components, such as a map pocket, an armrest, an instrument panel tray, an instrument panel bezel, a door bezel, a console lid, or a pillar cover, just to name a few.

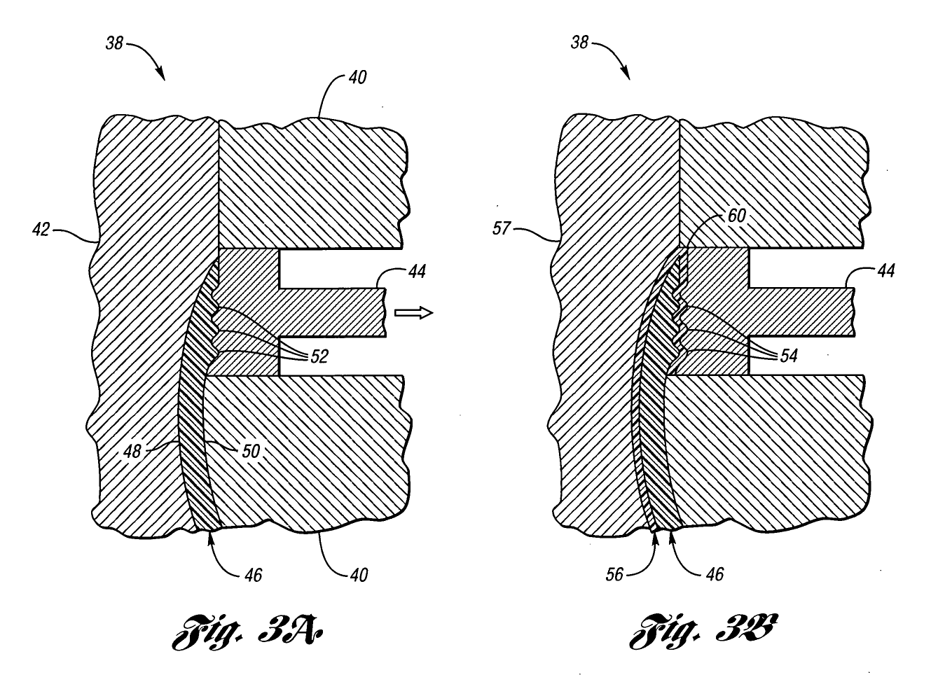

Depending on the particular application, and indeed the particular vehicle trim component being made, a two-shot polymeric component in accordance with the present invention may have any of a number of different configurations. For example, FIGS. 3A and 3B show a portion of a mold 38 used to form a two-shot polymeric component that provides a grip region for a vehicle occupant. This configuration may be particularly useful for components such as map pockets, armrests, or instrument panel trays, where an occupant's hand will be placed inside a portion of the component. For example, FIG. 3A shows a mold core 40 which cooperates with a first cavity 42 and a slide 44 to facilitate molding of a structural portion, or first shot 46. The first shot 46 includes a show side 48 and back side 50. In addition, the first shot 46 includes a plurality of ribs 52 formed in the back side 50, thereby providing a grip region for a vehicle occupant.

The shape of the ribs 52 is determined by the shape of the slide 44, which, as shown in FIG. 3B, will also form corresponding ribs 54 in the second shot 56. Similar to molding the second shot 32, shown in FIG. 2B, molding the second shot 56 is facilitated by retracting the slide 44, and rotating into place a second cavity 57. In this type of vehicle trim component, it may be convenient to form the second shot 56 from a relatively soft polymeric material, such as one or more of those mentioned above. Using such a material, in combination with the ribs 54, provides a vehicle occupant with a relatively secure grip region that results from the geometry of the ribs 54 and the compliance of the polymeric material of the second shot 56.

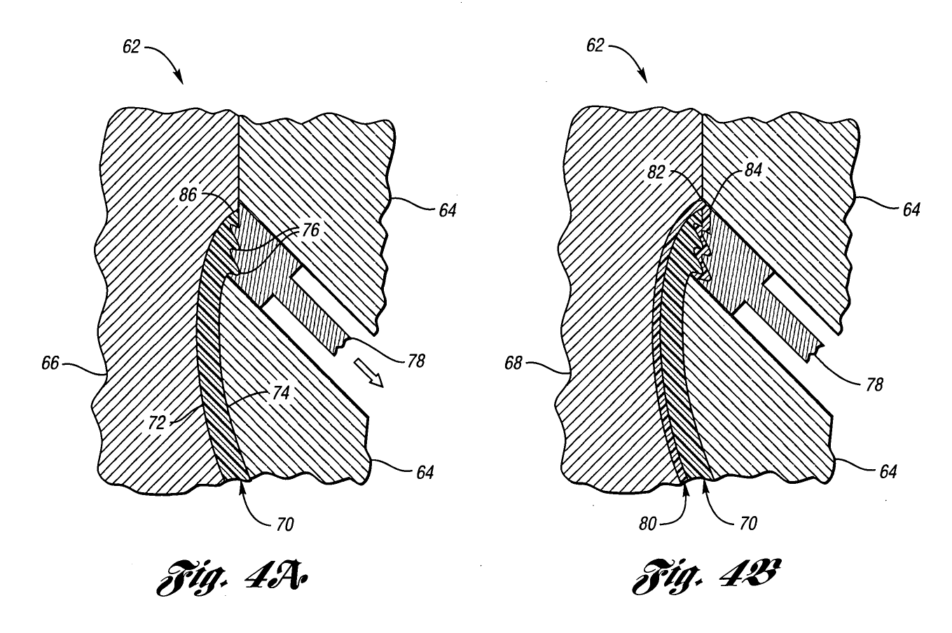

Returning to FIGS. 2A and 2B, it is shown that the slide 16 retracts in a direction that is generally perpendicular to the back side 30 of the first shot 24. This results in the forming of a 90° corner 58 in the second shot 32—see FIG. 2B. Similarly, the vehicle trim component shown in FIG. 3B has a 90° corner 60 formed in the second shot 56. Even though the show side 48 of the first shot 46 is curved, the 90° corner 60 is still formed in the second shot 56. In some applications, it may be desirable to form the second shot without a 90° corner, thereby providing a smoother transition over the edge. FIGS. 4A and 4B illustrate how such a component may be formed.

A mold 62 includes a core 64 and first and second cavities 66, 68. The first shot 70 is configured similarly to the first shot 46 shown in FIGS. 3A and 3B. In particular, the first shot 70 includes a show side 72 and a back side 74. In addition, the first shot 70 includes a plurality of ribs 76 formed in the back side 74. One difference between the ribs 76 and the ribs 52, shown in FIG. 3A, is that the ribs 76 are angled downward as viewed in FIG. 4A. Similarly, a retractable slide 78 is also angled downward so that it can pull straight back from the ribs 76. As shown in FIG. 4B, a second shot 80 has two corners 82, 84 in the region around an edge 86 of the first shot 70. As clearly shown in FIG. 4B, neither of the corners 82, 84 have a 90° angle. Rather, the corners 82, 84 provide a smooth transition from the show side 72 to the back side 74, around the edge 86. Such a configuration may provide a more comfortable feel for a vehicle occupant who reaches into a vehicle trim component, such as a map pocket or an instrument panel tray. Thus, the present invention not only provides the advantages of reduced labor and production costs over previous methods, but also provides an aesthetically pleasing component that can be used in a wide variety of applications.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method for producing a two-shot polymeric component having one shot wrapped around an edge of another shot, the method comprising:
injection molding a first portion having first and second opposing sides and an edge adjacent the first and second sides; and
injection molding a second portion such that some of the second portion contacts the first side of the first portion, some of the second portion contacts the second side of the first portion, and some of the second portion contacts the edge, the second portion forming a unitary structure wrapping around the edge of the first portion.

2. The method of claim 1, wherein injection molding the first portion includes filling at least a portion of a mold with a polymeric material, and
wherein injection molding the second portion includes providing at least one space around at least some of the first portion, including at least some of the first side, at least some of the second side, and at least some of the edge, and filling the at least one space with a polymeric material.

3. The method of claim 1, the two-shot polymeric component being injection molded in a mold including first and second cavities, a core, and a retractable slide,
wherein injection molding the first portion includes filling the first cavity with a polymeric material, and
wherein injection molding the second portion includes disposing the second cavity adjacent one side the first portion, retracting the slide, thereby forming a gap adjacent the opposing side of the first portion and communicating with the second cavity, and filling the second cavity and gap with a polymeric material, thereby forming the second portion.

4. The method of claim 3, wherein the slide is retracted in a direction generally perpendicular to the second side of the first portion, thereby forming in the second portion an edge having at least one 90° corner.

5. The method of claim 3, wherein the slide is retracted at an angle to the second side of the first portion, such that in the second portion an edge is formed without 90° corners.

6. The method of claim 3, the slide including a first wedge, the mold further including a second wedge cooperating with the first wedge to facilitate linear movement of the slide, wherein retracting the slide includes moving the second wedge away from the first wedge, thereby facilitating retraction of the slide.

7. The method of claim 6, the mold further including a spring cooperating with the first wedge to apply a force thereto, wherein moving the second wedge away from the first wedge allows the force of the spring to move the first wedge, thereby retracting the slide.

8. A method for producing a two-shot vehicle trim component having one shot wrapped around an edge of another shot, the method comprising:
injection molding a structural portion having a show side and a back side and an edge adjacent the show side and the back side; and
injection molding a skin such that some of the skin contacts the show side of the structural portion, some of the skin contacts the back side of the structural portion, and some of the skin contacts the edge, the skin forming a unitary structure wrapping around the edge of the structural portion.

9. The method of claim 8, wherein injection molding the structural portion includes forming at least one rib in the back side, thereby forming a grip region for a vehicle occupant.

10. The method of claim 8, the two-shot polymeric component being injection molded in a mold including first and second cavities, a core, and a retractable slide,
wherein injection molding the structural portion includes filling the first cavity with a polymeric material, and
wherein injection molding the skin includes disposing the second cavity adjacent the show side of the structural portion, retracting the slide, thereby forming a gap adjacent the back side of the structural portion and communicating with the second cavity, and filling the second cavity and gap with a polymeric material, thereby forming the skin.

11. The method of claim 10, wherein the structural portion is injection molded from polypropylene, acrylonitrile butadiene styrene, or polycarbonate acrylonitrile butadiene styrene, and the skin is injection molded from a thermoplastic elastomer, a thermoplastic polyolefin, or a thermoplastic vulcanizate.

12. The method of claim 10, wherein disposing the second cavity adjacent the show side of the structural portion includes rotating the first cavity away from the structural portion and rotating the second cavity into position adjacent the structural portion.

13. The method of claim 10, wherein the slide is retracted in a direction generally perpendicular to the back side of the structural portion, thereby forming in the skin an edge having at least one 90° corner.

14. The method of claim 10, wherein the slide is retracted at an angle to the back side of the structural portion, such that in the skin an edge is formed without 90° corners.

15. The method of claim 10, the slide including a first wedge, the mold further including a second wedge cooperating with the first wedge to facilitate linear movement of the slide, wherein retracting the slide includes moving the second wedge away from the first wedge, thereby facilitating retraction of the slide.

16. The method of claim 15, the mold further including a spring cooperating with the first wedge to apply a force thereto, wherein moving the second wedge away from the first wedge allows the force of the spring to move the first wedge, thereby retracting the slide.

17. A two-shot injection molded polymeric component, comprising:
a first portion having first and second opposing sides and an edge adjacent the first and second sides; and
a second portion molded over at least some of the first and second sides and the edge of the first portion, the second portion forming a unitary structure that wraps around the edge of the first portion.

18. The polymeric component of claim 17, the polymeric component being a vehicle interior trim component, wherein the first portion forms a structural portion and the second portion forms a skin, and
wherein the vehicle interior trim component is a map pocket, an arm rest, an instrument panel tray, an instrument panel bezel, a door bezel, a console lid, or a pillar cover.

19. The polymeric component of claim 18, wherein the structural portion has at least one rib formed in the back side, thereby providing a grip region for a vehicle occupant.

20. The polymeric component of claim 18, wherein the structural portion is made from polypropylene, acrylonitrile butadiene styrene, or polycarbonate acrylonitrile butadiene styrene, and
wherein the skin is made from a thermoplastic elastomer, a thermoplastic polyolefin, or a thermoplastic vulcanizate.
